(19) United States
(12) Patent Application Publication
(10) Pub. No.: US 2008/0290609 A1
(43) Pub. Date: Nov. 27, 2008

(54) Carrier Frame Seal with Mount Points to Seal Motor Components

(75) Inventors: Gerhard Seibert, Karlsruhe (DE); Werner Kratzmeier, Bretten (DE)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL SEALING SYSTEMS BRETTEN GMBH & co. kg, 75015 BRETTEN GERMANY (DE)

(21) Appl. No.: 11/628,878

(22) PCT Filed: Mar. 14, 2005
(86) PCT No.: PCT/EP05/02705

§ 371 Date: Jan. 8, 2008

(30) Foreign Application Priority Data
Jun. 8, 2004 (DE) 10-2004-027-843.1

(51) Int. Cl. F02F 11/00

(52) U.S. Cl. 277/596

(57) ABSTRACT

The invention relates to a frame member seal comprising at least two fixing devices, which are configured from plastic or elastomer and are designed to project in corresponding orifices in front of at least one component that is to be sealed.

The invention before you addresses carrier frame seals, which include metallic carriers and/or metallic seal layers. The invention specifically addresses carrier frame seals, which include alignment elements or position alignment elements to position the carrier frame seal relative to a component. This invention before you especially relates to a carrier frame seal, in which the positioning is accomplished over a sprayed-on positioning alignment element also known as a ‘positioning dome.’ Such carrier frame seals are well-suited for seals in motor elements or cylinder assembly elements in combustion engines, for example, such as in valve seals or on the oil pan.

A problem arises in carrier frame seals where a carrier frame seal must be aligned onto a sealing surface in such a manner that will assure a secure positioning of the seal during assembly of the components to be sealed.

In each type of seal for surfaces to be sealed between two different components the problem arises of how to position and to align the seal with reference to the two surfaces.

In the state-of-the-art carrier frame seals are aligned using alignment holes, alignment tabs or screws on one part or the other for positioning. This is the typical method of alignment positioning, so that the two components may be aligned against each other.

In the state-of-the-art, for example under German usage practices in DE 201 05250, flat seals with pegged brackets are used for mounting onto the surfaces to be sealed, where the pegged brackets of the flat seal Are laid out diagonal to the surface area and take their effect in corresponding depressions on one of the component elements.

Combustion engines represent one area for use of flat seals, in which they may serve as cylinder head seals between the cylinder head and the cylinder block, for example. The components, which lie between the flat seals under operating conditions, are often transported or handled separately during assembly, such that the flat seal on one of the components or the other may already be attached. To prevent the loss of the flat seal, it is often firmly attached to the component.

These have been held in place up until now by screwing them down tightly. The preparation of screw connections has considerable preparatory and assembly effort associated. One known practice has also been to attached pegged brackets to the outside circumference of the flat seal, extending beyond the component element, and connected to the exterior areas. These available solutions require a considerable added cost in materials compared to the material actually required for the seal by itself, and an increased risk of injury exists due to the pegged brackets extending beyond the attached seals.

It is therefore the task of this invention before you to improve on the existing possibilities for aligning and attaching the seals, and especially carrier frame seals, for their mounting onto components.

It is worth the effort to try to avoid loss of a carrier frame seal on a motor-component (oil pan, cylinder head cover . . . ) by screwing them down.

It is also desirable to provide a further developed carrier frame seal, which allows the work process flow for mounting and sealing to be improved with the carrier frame seal.

The assigned task is solved by a carrier frame seal, having at least two mount points. The invention related mount points are formed of plastic or elastomer, such as rubber, and essentially extend vertically from the mount level. In the following text the term ‘plastic’ is used to refer to elastomer, rubber, and to elastomer/rubber materials. The mount points may be produced as elastomer-mount points. The mount points are set to protrude such that each has a corresponding opening on at least one of the components to be sealed.

In this fundamental execution, the mount points are essentially advanced forms of pins, pin stumps, mushroom-shaped stumps, ball stumps, cylinders or cylinder stumps, ellipsoid or ellipsoid stump-shaped and so on. The basic form or basic surface may essentially be round, polygonal or angled. In the following text the mount points are referred to as ‘mount domes’ to reflect advances in the form of pins, pin stumps, mushroom-shaped stumps, ball stumps, cylinders or cylinder stumps, ellipsoid or ellipsoid stump-shaped. The basic form or basic surface may essentially be round, polygonal or angled.

In basic implementation form the mount points or mount dome ensure that a good seal is achieved by locking into a corresponding opening on one of the components to be sealed. This makes a self-centered alignment of the seal possible during automated assembly, for example.

The use of plastic materials allows the mount points or mount dome to be formed of any preferred type of seal material. Plastic or advanced elastomers for example may be sprayed onto the carrier frame. The mount points can be produced from recycled materials, for example, because the mechanical demands of keeping the sealed components in place only apply for the period prior to assembly.

A metal frame is preferred for the carrier frame seal. The use of metal seals allows multiple layer carrier frame seals having at least one metal layer and seal. The mount points and mount domes can also be directly sprayed onto a metal seal by a spray-casting machine. It is specifically possible with metal seals to make the plastic mount dome from an easily degradable, possibly even biodegradable material. The mount dome can also be formed onto the carrier frame seal using vacuum deep drawing or some similar preparation technique.

The use of mount points or mount domes of plastic has the added advantage that even fully hardened metal seals may be used, without requiring any special processing steps for pegged brackets.

Preferably at least one of the metal fittings should be formed essentially vertical to the mount level in at least one of the mount points or mount domes. This can be achieved for example by a reforming technique such as deep drawing or edging. In this manner the plastic volume in the mount dome may be reduced. Beyond that the mount dome may be molded onto the carrier frame seal for mounting, that is that even plastic materials having minimal adhering capabilities may be used on the seal material or on the carrier frame. The plastic, elastomer or rubber domes can be accomplished with a brass core. This is accomplished using an elastomer dome, which may be executed with or without a brass core.

In a preferred execution form at least one metal fitting is reformed using a selected technique of pressing, folding, forging, stamping, punching, cutting, extrusion, deep drawing and drawing in such a manner as to extend in the direction of at least one mount dome.

By pressing, forging, stamping, deep drawing and drawing a mount dome-like structure can be formed from a seal material, which can have a positive effect on the amount of plastic material to be used.

By punching, cutting and extrusion a structure can be formed from one seal material, that has an especially good molding fit between the structure and the mount point or mount dome. It is possible to form a 3-dimensional structure by punching and folding, which can then add supplementary stability to the mount dome. It is thereby possible to make a cross-shaped or star-shaped cut, and to then to vertically fold the metal tongues upwards. This will result in a crown shape upon which a mount dome of plastic may be placed, to stabilize this structure. Cuplike structures having extruded metal walls are also possible.

Preferably at least one of the mount points or mount domes will have an opening which essentially extends vertical to the mount level. With rotation-symmetrical mount points the opening can lead along the symmetrical axis. An execution form of that type makes it possible to use a hole for a bolt to position the carrier frame seal, for example. In that way the need for special drilling to accept the mount dome in the parts to be sealed can be avoided.

It is advantageous for at least one of the mount domes to have the shape of a mount knob, a mount nose, a mount lip or bead on the outside. With a mount knob, -nose, -lip or -bead the mount point can be attached by a power connection or fitted connection in an opening on one of the components to be sealed. If the front edge of the mount point or mount dome is attached at the outside diameter of the mount point, and additionally a brass core is made in the dome, the fixing will occur on the basis of a power or friction connection. The carrier frame seal can thereby be positioned on the surfaces to be sealed as well as vertical to the surfaces to be sealed.

These implementation forms can thereby be accomplished such that an externally placed mount knob, a mount nose, a mount lip or bead can be sprayed on the carrier frame seal. The mount points are then fixed to the corresponding opening to the knob or nose by a power or friction connection to the motor block. The elastomer-mount points can be strengthened by a plastic or brass core. The carrier frame seal is fixed in place on the surfaces to be sealed, such that the mount dome can also serve as protection against loss of the seal.

In a preferred implementation at least one of the mount points or mount domes is equipped with a mount knob, a mount nose, or mount lip on the inner side of the opening of the mount point. Through use of knobs or noses on the elastomer mount or dome, a security against loss as well as ease in centering can be achieved. A mount lip on the inner side of a mount dome indicates the special advantage realized when screws or bolts are inserted through the opening in the dome, where they are held securely. In this manner a component can be prepared for delivery with only one seal and one screw or rivet package, making possible a simplified use of automation without using a screw-feeding tool. If the nose is placed on the inner section of the dome, the fixing will occur vertical to the surfaces to be sealed (a safety) with intervening by means of clicking-in of a band or a screw or hull.

This can be implemented in that mount points or mount domes are sprayed in at every screw mount point, using an elastomer material. These mount domes will receive either screws or screw sleeves snapped into place. The carrier frame seal will be held in place at the mount point by the inward-facing nose or lip with the band holding the screw or screw sleeve. The seal and the decoupling element (or screw) can be mutually pre-mounted on one motor component.

In this implementation a power or friction connection to the mount points or mount dome from the component is not necessary because a connecting element is already connected to the carrier frame seal.

The elastomer or rubber domes are equipped with knobs or noses, which are attached on the outer or inner edges.

Multiple mount points may be used which lead to/away from each other. Multiple mount lips may be mounted one after another. It is also possible to implement a movable mount lip so that it is on the outer or the inner side, turning with the mounting point.

The invention before you enables loss-prevention by form-fitting with the screw/screw-sleeve solution and/or with a power or friction connection on the outer side of the mount point through an exterior elastomer nose.

It is preferred that the mount knob, nose, lip be of a different plastic material than the mount point is made of. In this way at least a rubber or elastomer lip can be formed for a mount point made of plastic.

It is preferred that the carrier frame seal exhibit at least two mount points or mount domes which extend from the mount level in different directions. In this way the seal will self-destruct when the components to be sealed are taken apart after assembly, in that at least one of the mount domes remains on one part, and at least one other mount dome remains on another mount, and the seal is torn at separation.

In one further preferred implementation at least two of the mount points or mount domes which extend from the mount level in different directions, will lie essentially on a common axis. In this way the mount domes of the two parts can hold the two parts in a given direction against other. In this way one could possibly avoid use of a specialized structure to align the components against each other.

It is preferred that at least one of the mount points or mount domes use a guide rod. The integration of a guide rod into the seal or into the mount dome can reduce the number of hand-touches required for assembly of the two parts, because a separate step is no longer needed for the assembly of the guide rod or for the seal, which is difficult to handle, being an elastic component.

It is preferred that at least one mount point or mount dome incorporate a strengthening element. This strengthening element may be implemented for an example as a plastic or a metal ring. The strengthening element can be implemented as a plastic or a metal sleeve. The strengthening element can be implemented as a plastic or a metal rod. By introducing a reinforcement in the form of a supplemental brass core in the mount dome, the seal can be aligned in the level of the surfaces to be sealed.

The brass core in the mount point or mount dome can be implemented in such a way that it will align the seal in a preferred direction parallel to the seal surface, centered. This can be achieved for example by use of an oval brass core. Through this centering dome the carrier frame seal can be aligned in the installation layout according to one direction or for multiple directions for the layout of the surfaces to be sealed.

The invention is described in more detail below on the basis of the drawing.

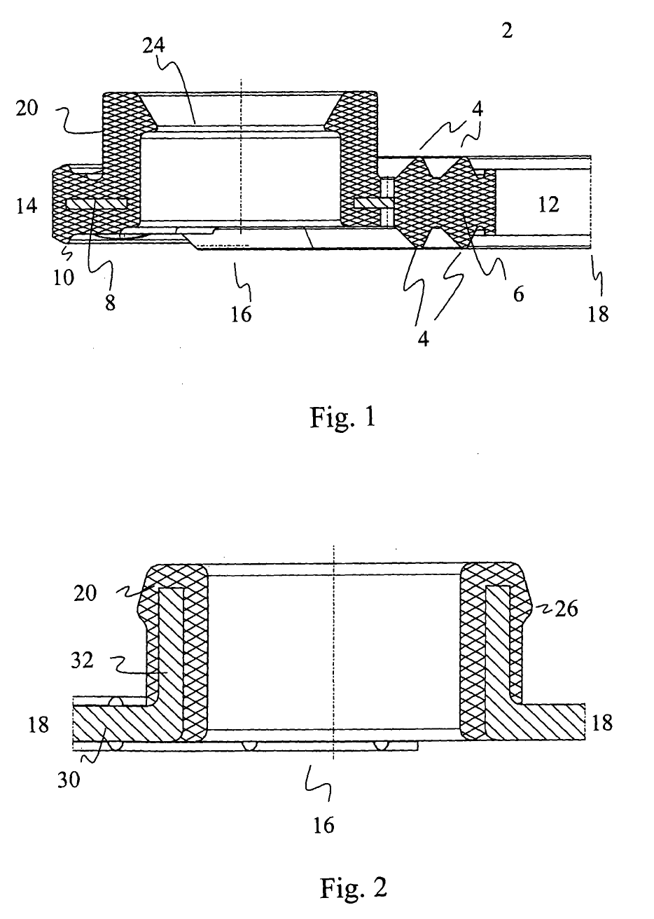

FIG. 1 shows a cross-section of a mount dome in a carrier frame seal made of plastic.

FIG. 2 shows a cross-section of another mount dome made of plastic with a metal reinforcement.

FIG. 3 depicts a carrier frame of a carrier frame seal in a perspective component view.

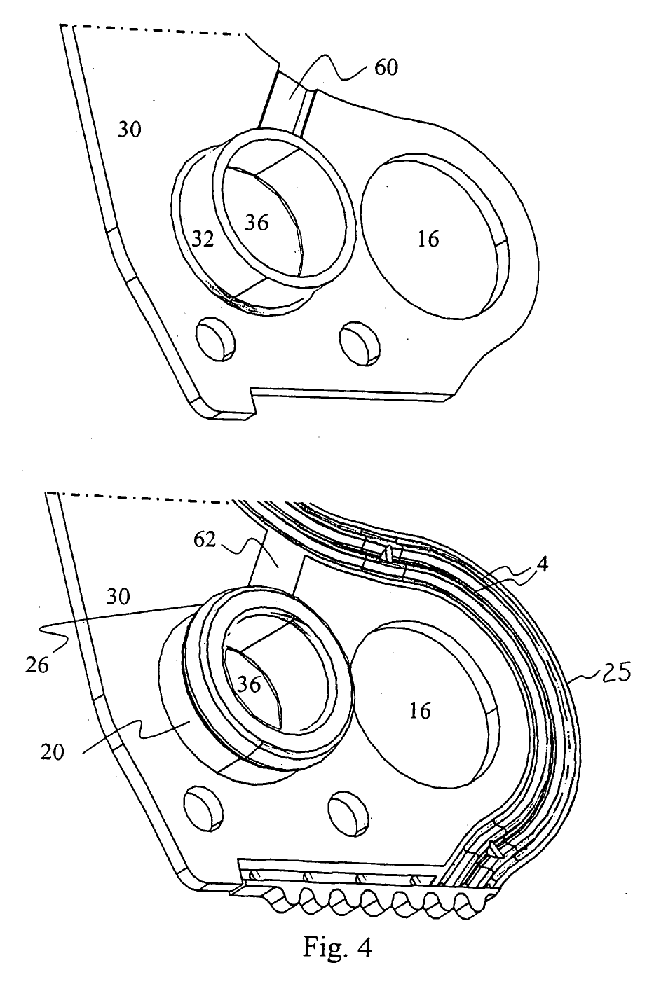

FIG. 4 shows a carrier frame seal with the carrier frame from FIG. 3 in a perspective component view.

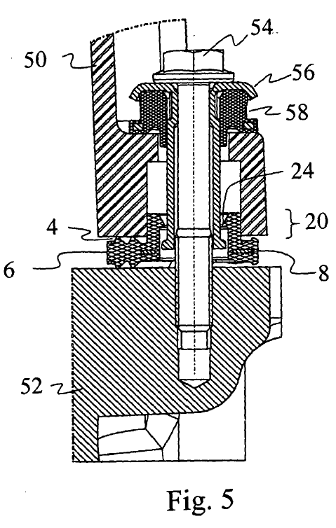

FIG. 5 shows a cross-section of a mounted carrier frame seal as described in the invention.

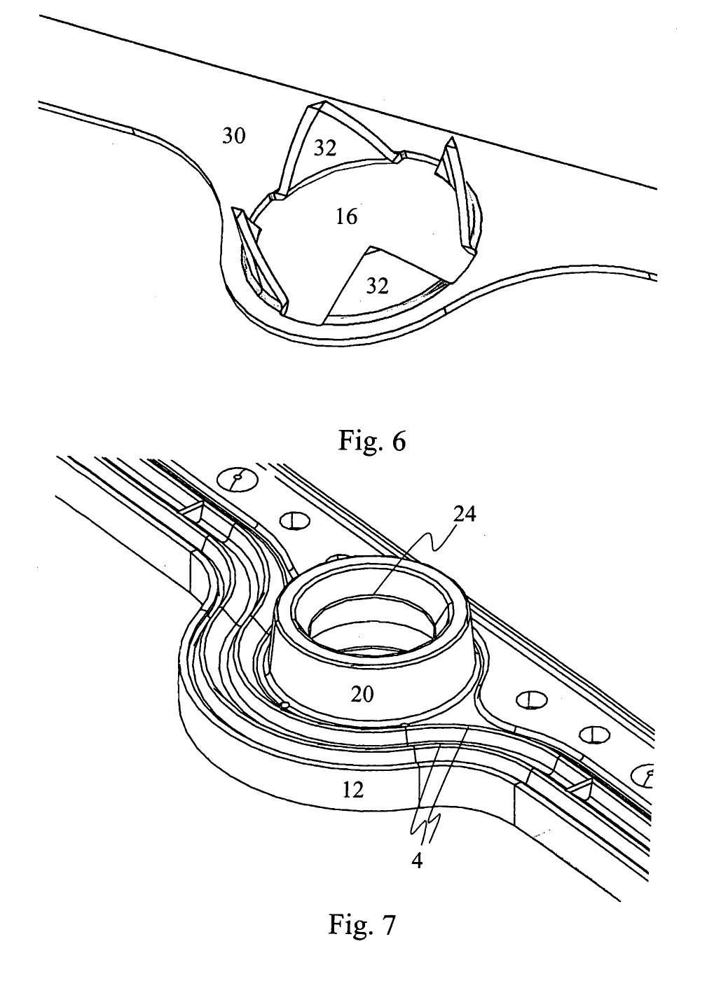

FIG. 6 depicts a further carrier frame of a carrier frame seal in a perspective component view.

FIG. 7 shows a carrier frame seal with the carrier frame from FIG. 6 in a perspective component view.

In the figures as well as in the descriptions the same reference marks are used, to allow comparison of similar or of identical components or elements.

FIG. 1 shows a cross-section of a mount dome or a mount point in a carrier frame seal made of plastic. The carrier frame seal 2 is presented with seal lips 4. The carrier frame seal 2 presented consists essentially of an elastomer material 6. The carrier frame seal 2 is equipped with a reinforcing fitting 8. The carrier frame seal 2 includes an area to be sealed 12 and an exterior side 14, which is equipped with a further seal lip 10. That reference mark 18 designates a line of intersection in the presentation.

The carrier frame seal 2 shows a drill hole or a bolt hole 16 through which a connecting bolt can connect the components to be sealed (not shown).

The carrier frame seal 2 equipped with a mount point or a mount dome 20 around the bolt hole 16. The mount dome 20 is equipped with an internal nose or lip 24, with which the mount dome can attach to an element protruding through the bolt hole 16.

The first implementation form is aimed at small elastomer-carrier frame seals having a small reinforcing element 8.

FIG. 2 shows a cross-section of another mount dome of plastic having a metal reinforcement. In contrast to the mount dome 20 in FIG. 1, the mount dome in FIG. 2 is equipped with a reinforcement 32. The reinforcement in the implementation form as represented here is directly formed from a carrier element 30. The carrier element 30 may be made of plastic or metal, or may consist of a cloth material. For a metal carrier frame fitting 30 the reinforcement may be produced using deep drawing of assembly stamping, for example. In a variation from FIG. 1, the mount dome 20 in FIG. 2 features an outer nose or lip 26, with which the mount dome can connect into an opening in one of the to-be-sealed elements.

FIG. 3 represents a carrier element 30 with a carrier frame seal with a molded-in reinforcement 32 for a mount dome. The molded-in reinforcement 32 is equipped with a pass-through opening 36. The carrier element has a bolt hole 16. The carrier element also exhibits a form channel 60.

FIG. 4 shows a carrier frame seal with carrier frame 30 from FIG. 3 in a perspective component view. In FIG. 4 the carrier frame 30 has a seal structure 25 made of elastomer material. The seal structure includes the seal lips 4. The molded reinforcement is covered with elastomer material. The elastomer material over the reinforcement, along with the outer lips 26 makes up the mount dome 20. The elastomer material of the seal structure and of the mount dome can be sprayed in one work step, on the basis of the (in the meantime filled with elastomer material 62) form channel 60.

FIG. 5 shows a cross-section of a mounted carrier frame seal, as per this invention. The carrier frame seal lies between two components to be sealed 50, 52. The seal corresponds essentially to the implementation form represented in FIG. 1. The two components to be sealed 50, 52 are connected by a screw bolt 54. The screw bolt is equipped with an over-pressure limiting sleeve 56, which determines the maximum depth for screw bolt 54. The unit element 50 is firmly attached to the bolt 54 and to the over-pressure limiting sleeve 56 through the decoupling element 58. In that way unit element 50 is no longer stiffly mechanically coupled to unit element 52, and therefore will not suffer damage due to vibrations, nor will noise be generated through impact of components 50, 52, or of unit element 50 against bolt 54.

FIG. 6 demonstrates a further execution form of a carrier element 30 of a carrier frame seal in a perspective component view. The carrier frame seal 15 includes a bolt hole 16, where the material of the carrier element 30, which was previously in the area of bolt hole 16, is reformed into a crown shape. This reforming builds the triangular (or also rectangular) reinforcement 32, which is essentially vertical to the mount level extrusion. The reinforcements 32 serve to strengthen a later mount point to be attached. It is also possible to only use two reinforcements 32, for example, which are aligned across from each other, to align the carrier frame seal in one preferred direction.

FIG. 7 shows a carrier frame seal with the carrier element 30 of FIG. 6 in a perspective component view. The individually recognizable elements have already been described in FIG. 1.

The positioning of the seal onto the surfaces to be sealed is possible without any additional components such as a guide rod or a guide sleeve, because the mount points or mount dome are integrated into the carrier frame seal.

Even large carrier frame seals can be positioned into place on the surfaces to be sealed with assurance.

The invention before you can also be used outside of the identified application areas, for automated assembly procedures for carrier frame seals in which, for example, the mount points or mounts are used as the starting point for hand/touch tool work.

1-14. (canceled)

15. A carrier frame seal for sealing components and having at least two mount assemblies formed of plastic or elastomer arranged in a manner to correspond to associated openings in at least one of the components to be sealed.

16. The carrier frame seal of claim 15, wherein the mount assemblies comprise mount domes.

17. The carrier frame seal of claim 16 wherein the mount domes comprise at least one form selected from the group consisting of pins, pin stumps, mushroom-shaped stumps, ball stumps, cylinders, cylinder stumps, ellipsoids or ellipsoid stumps.

18. The carrier frame seal of claim 15 including at least one metal fitting.

19. The carrier frame seal of claim 18 wherein said at least one metal fitting extends generally vertically in at least one of said at least two mount assemblies.

20. The carrier frame seal of claim 19 wherein the generally vertically extending portion of the said at least one metal fitting is formed as a formed metal projection of said at least one metal fitting and selected as a feature which is pressed, folded, forged, stamped, punched, cut, extruded, deep drawn or drawn.

21. The carrier frame seal of claim 15 wherein at least one of said at least two mount assemblies includes a least one opening which extends generally vertically.

22. The carrier frame seal of claim 15 wherein at least one of said at least two mount assemblies includes an exterior mount feature in the form of a mount knob, nose, lip or bead.

23. The carrier frame seal of claim 22 wherein said exterior mount feature is fabricated out of a different plastic than that of said mount assembly.

24. The carrier frame seal of claim 21 wherein at least one of said at least two mount assemblies includes an interior mount feature in the opening in the form of a mount knob, nose, lip or bead.

25. The carrier frame seal of claim 24 wherein said interior mount feature is fabricated out of a different plastic than that of said mount assembly.

26. The carrier frame seal of claim 15 wherein said at least two mount assemblies extend in opposite directions from one another.

27. The carrier frame seal of claim 26 wherein said at least two mount assemblies lie along a common axis.

28. The carrier frame seal of claim 15 wherein at least one of said at least two mount assemblies includes a guide rod.

29. The carrier frame seal of claim 15 wherein at least one of said at least two mount assemblies includes a reinforcing element.

30. The carrier frame seal of claim 15 including a carrier frame made of elastomer.
